(19) United States
(12) Patent Application Publication
(10) Pub. No.: US 2011/0290125 A1
(43) Pub. Date: Dec. 1, 2011

(54) SERVO PRESS APPARATUS DRIVEN BY MULTIPLE MOTORS

(75) Inventors: Takao Ito, Sagamihara (JP); Takashi Koshimizu, Zama (JP); Hiroshi Nagase, Sagamihara (JP)

(73) Assignee: AIDA ENGINEERING, LTD., Kanagawa (JP)

(21) Appl. No.: 13/042,752

(22) Filed: Mar. 8, 2011

(30) Foreign Application Priority Data
May 28, 2010 (JP) 2010-122998

(51) Int. Cl. B30B 15/00

(52) U.S. Cl. 100/214

(57) ABSTRACT

This invention is intended to provide a large-capacity servo press apparatus driven by multiple motors, the servo press apparatus enabling a drive at a high efficiency and with reduced torque pulsations in a simple structure. The disclosed servo press comprises a slide that is moved up and down by a plurality of crank structures (including eccentric rings and connecting rods), main gears that drive the crank structures, a plurality of drive gears interlinked with the main gears directly or indirectly, intermediate gears interlinked with the main gears directly or indirectly, and servo motor sets connected to drive shafts to drive the drive gears. In each of the servo motor sets, a plurality of servo motors are directly connected to each servo motor shaft.

### FIELD OF THE INVENTION

The present invention relates to a large-scale servo press apparatus, particularly, a large-capacity servo press apparatus driven by multiple servo motors.

### BACKGROUND OF THE INVENTION

Servo press machines driven by a servo motor are capable of a variety of slide motions. Therefore, the servo press machines are useful, for example, for facilitating a drawing operation by slowing down immediately before a press load is applied, or for noise reduction, or for productivity improvement by a so-called pendulum motion, i.e., up and down movement of a slide near the bottom of the stroke of the slide. A large-scale servo press apparatus uses a multipoint drive in which the force is applied to multiple points on the slide. Due to this, a servo motor to drive the press is required to be larger and have a larger capacity. In consequence, it is adopted to drive the press with multiple motors. A large-capacity servo press driven by multiple motors can be realized.

### SUMMARY OF THE INVENTION

According to Japanese Laid-Open Patent Application No. 2004-17089, contrivance that enables a large-scale press with two motors is described. However, this document does not specify how motors are arranged for a larger scale press for which the capacity of the two motors becomes insufficient. According to Japanese Laid-Open Patent Application No. 2001-62596, contrivance that enables a larger-scale press by increasing the number of motors placed on a crankshaft is described. However, a motor that directly drives a crankshaft is required to yield very much torque and there is a problem of enlarging the motor itself.

Further, according to Specification of U.S. Pat. No. 7,102,316, contrivance that enables a larger-scale press by using four motors is described. However, one problem hereof is a complicated press structure in which the motors' torques are transmitted via gears attached to the respective motors. Another problem is an increase in loss due to the fact that the force is applied to multiple points on the slide and gears to drive the force applied points are interlinked using intermediate gears. A point that is not taken into account in all of the above-mentioned patent documents is reducing torque pulsations generated by the respective motors, thereby enhancing a drive. Therefore, a problem may be encountered in terms of accuracy of positioning the slide, responsiveness, and noise.

The present invention has been made to address the above-noted problems and is intended to provide a large-capacity servo press apparatus driven by multiple motors, the servo press apparatus enabling a drive at a high efficiency and with reduced torque pulsations in a simple structure.

In a servo press having a plurality of servo motor shafts, the present invention realizes a large-capacity servo press by placing a plurality of servo motors directly on each of the servo motor shafts.

More specifically, a first aspect of the present invention resides in a servo press apparatus driven by multiple motors, the servo press comprising a slide that is moved up and down by a plurality of crank structures, a gear train that interconnects the crank structures directly or indirectly, and a plurality of servomotor shafts connected to the gear train, wherein a plurality of servo motors are directly placed on each of the servo motor shafts.

A second aspect of the present invention resides in the servo press apparatus driven by multiple motors according to the first aspect, wherein the crank structures are connected to main gears, the main gears are interlinked with drive gears connected to the servo motor shafts, and the main gears are interconnected directly or via intermediate gears.

A third aspect of the present invention resides in the servo press apparatus driven by multiple motors according to the first aspect, wherein the crank structures are connected to main gears, the main gears are interlinked via intermediate gears with drive gears connected to the servo motor shafts, and the main gears are interconnected directly or via intermediate gears.

A fourth aspect of the present invention resides in the servo press apparatus driven by multiple motors according to any of the first through third aspects, wherein a plurality of servo motors are placed on a servo motor shaft such that the servo motors are arranged on either side and/or one side of a drive gear placed on the servo motor shaft connected to the gear train.

A fifth aspect of the present invention resides in the servo press apparatus driven by multiple motors according to any of the first through third aspects, wherein a plurality of servo motors are placed on a servo motor shaft such that the servo motors are arranged in a tandem structure within a same frame.

A sixth aspect of the present invention resides in the servo press apparatus driven by multiple motors according to any of the first through fifth aspects, wherein a plurality of servo motors are placed on a servo motor shaft such that the phases of the servomotors differ from one another with respect to the axis of rotation in order to cancel out mutual torque pulsations of the motors.

A seventh aspect of the present invention resides in the servo press apparatus driven by multiple motors according to any of the first through sixth aspects, wherein an encoder is attached to each of the servo motor shafts and a plurality of servomotors placed on one of the servomotor shafts are controlled by the encoder attached to the servo motor shaft.

An eighth aspect of the present invention resides in the servo press apparatus driven by multiple motors according to the seventh aspect, wherein one of the servomotor shafts is regarded as a master shaft and control of a plurality of servo motors is implemented.

According to the first, second, and third aspects of the present invention, the servo press apparatus, in which a plurality of motors are placed on a same drive shaft, provides for complete synchronization of the right and left crank structures by means of the gear train and enables a drive with fewer gears. Thus, the servo press apparatus provides the following advantages: simple structure; small loss; downscalable; highly-responsive operation with small inertia moment is practicable; impervious to accuracy deterioration due to gear backlash; and less gear duty, as a sum of torques produced by a set of motors is only exerted on each gear.

According to the fourth aspect of the present invention, in addition to the above-noted advantages, because the servo motor shafts can be made shorter, the servo press apparatus provides a further advantage in which it can be further downscaled.

According to the fifth aspect of the present invention, in addition to the above-noted advantages, because the servo motor shafts can be made even shorter, the servo press apparatus provides a further advantage in which it can be even more downscaled.

According to the sixth aspect of the present invention, in addition to the above-noted advantages, the servo press apparatus provides a further advantage in which operation with reduced torque pulsations can be performed.

According to the seventh aspect of the present invention, in addition to the above-noted advantages, because the number of encoders can be decreased, the servo press apparatus provides a further advantage in which a drive with a high reliability can be achieved.

Moreover, according to the eighth aspect of the present invention, in addition to the above-noted advantages, the servo press apparatus provides a further advantage in which a well-balanced operation between or among a plurality of motors can be accomplished.

### BRIEF DESCRIPTION OF THE DRAWINGS

FIG. 1 is a structural diagram of a first embodiment of the present invention.

FIG. 2 is a transverse sectional view of the first embodiment of the present invention.

FIGS. 3A, 3B, 3C, and 3D illustrate arrangements of motors according to the first embodiment of the present invention.

FIG. 4 is a diagram illustrating how the motors are connected according to the first embodiment of the present invention.

FIG. 5 is a diagram illustrating a torque characteristic when the motors are connected according to the first embodiment of the present invention.

FIG. 6 is a block diagram of a control system according to the first embodiment of the present invention.

FIG. 7 is a structural diagram of a second embodiment of the present invention.

FIGS. 8A, 8B, 8C, and 8D illustrate arrangements of motors according to the second embodiment of the present invention.

FIG. 9 is a structural diagram of a third embodiment of the present invention.

FIGS. 10A, 10B, 10C, and 10D illustrate arrangements of motors according to the third embodiment of the present invention.

FIG. 11 is a structural diagram of a fourth embodiment of the present invention.

FIG. 12 is a structural diagram of a fifth embodiment of the present invention.

### DETAILED DESCRIPTION OF THE PREFERRED EMBODIMENTS

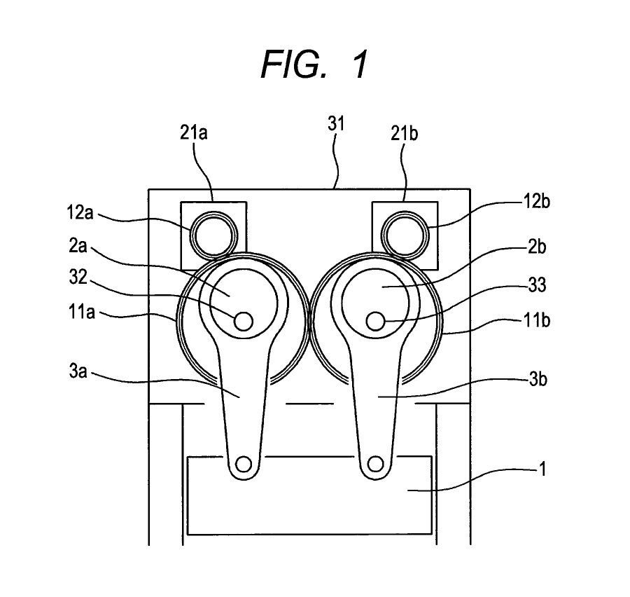

Embodiments of the present invention will be described hereinafter by means of FIGS. 1 through 12.

### First Embodiment

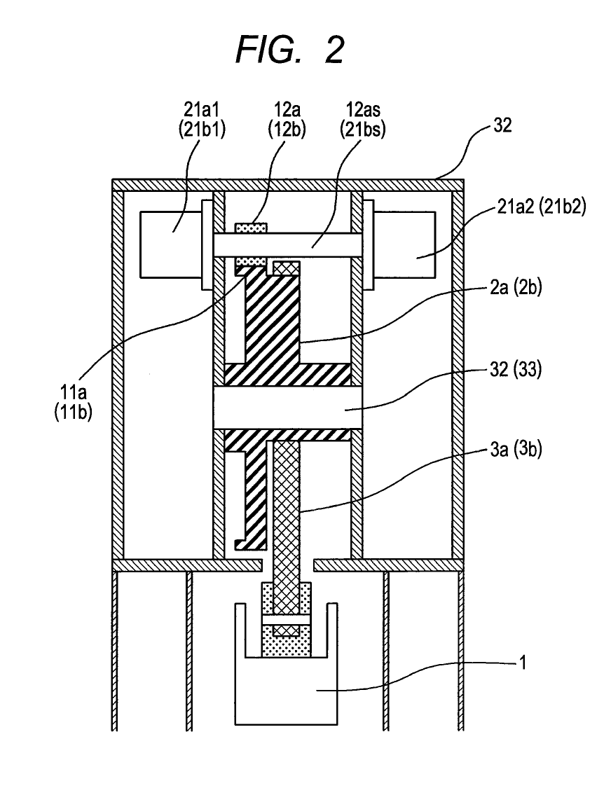

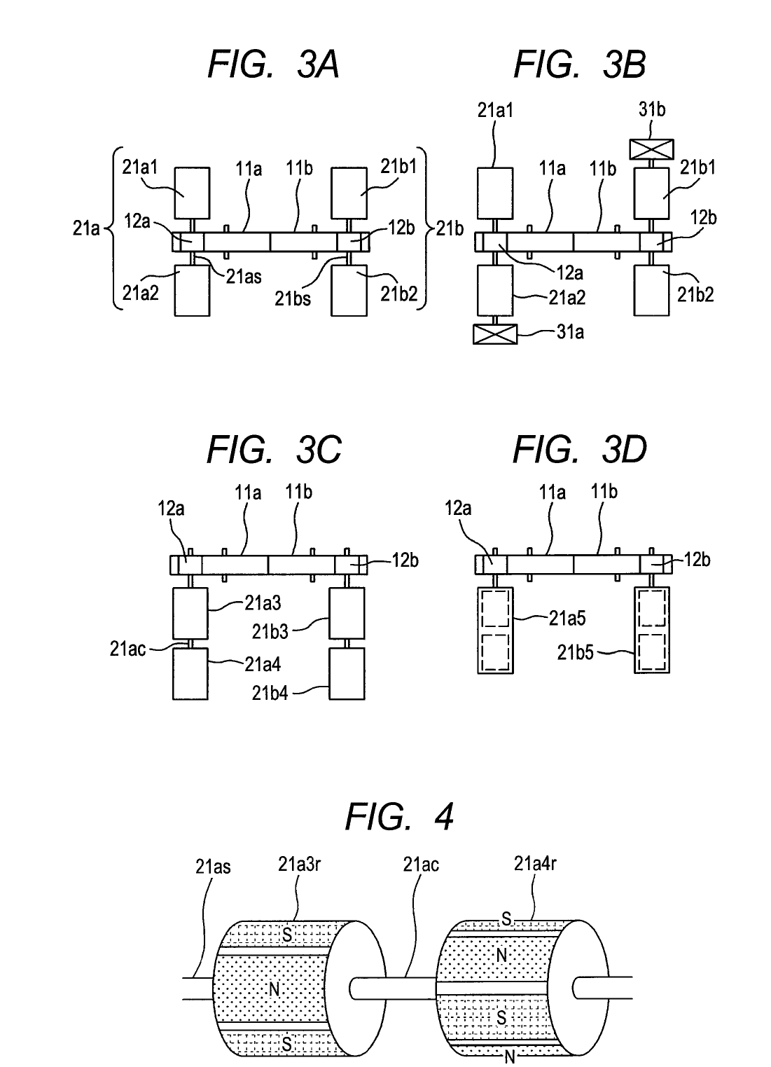

FIGS. 1, 2, and 3A to 3D illustrate a press apparatus of a first embodiment of the present invention. These figures schematically represent only an operating section pertaining to the present invention. FIG. 1 is a structural diagram as viewed from front. FIG. 2 is a transverse sectional view. FIGS. 3A, 3B, 3C, 3D illustrate arrangements of motors as viewed from a top plane. The press has a structure of an eccentric press.

First, the structure is described with reference to FIGS. 1 and 2. A set of servomotors (servo motor set) 21a is installed in the servo press apparatus's frame 31. An output shaft of the servo motor set 21a is connected to a drive shaft 21as which is directly connected thereto. A plurality of servo motors is connected to the motor output shaft or the drive shaft. Herein, this set of the servo motors is referred to as a servo motor set. A drive gear 12a is provided on the drive shaft 21as. A pin 32 is provided in the frame 31. Both ends of the pin 32 are fixed to the frame 31.

An eccentric ring 2a engages with the pin 32. Amain gear 11a is fixed to the eccentric ring 2a. The main gear 11a meshes with the drive gear 12a.

The eccentric ring 2a rotates together with the main gear 11a. An eccentric portion of the eccentric ring 2a engages with a hole in a large-diameter portion of a connecting rod 3a. A lower end of the connecting rod 3a is connected to a slide 1.

A servo motor set 21b is also installed in the servo press apparatus's frame 31. An output shaft of the servo motor set 21b is connected to a drive shaft 21bs. A drive gear 12b is provided on the drive shaft 21bs. A pin 33 is provided in the frame 31. Both ends of the pin 33 are fixed to the frame 31.

An eccentric ring 2b engages with the pin 33. A main gear 11b is fixed to the eccentric ring 2b. The main gear 11b meshes with the drive gear 12b. The eccentric ring 2b rotates together with the main gear 11b. An eccentric portion of the eccentric ring 2b engages with a hole in a large-diameter portion of a connecting rod 3b. A lower end of the connecting rod 3b is connected to the slide 1. The main gears 11a and 11b mesh with each other.

The slide 1 is moved up and down by a crank mechanism comprised of the eccentric ring 2a and the connecting rod 3a and a crank mechanism comprised of the eccentric ring 2b and the connecting rod 3b. That is, the slide 1 is moved up and down by a crank structure and by the aid of rotation of the main gears 11a and 11b.

Torque of the servo motor set 21a is directly transmitted to the main gear 11a, whereas torque of the servo motor set 21b is directly transmitted to the main gear 11b. In the present embodiment, no additional gear is provided in order to synchronize the main gears. The structure as described above provides for synchronization of the right and left main gears 11a and 11b, that is, synchronously moving up and down of the force applied points on the slide.

For the servo motor sets 21a, 21b, in either case, a plurality of servo motors are connected to a same shaft. The sectional view of FIG. 2 depicts the structure in which the motors are arranged as in FIG. 3A, which will be described later.

The crank mechanisms are rotationally driven freely by controlling the normal rotation, reverse rotation and variable speeds of the servo motor sets 21a, 21b. Thus, it is possible to flexibly set a variety of slide motions such as slide motions other than the crank mechanisms, accelerated and decelerated motions including standstill suitable for a molding method, or normal/reverse pendulum motion. These motions can be used in any combination or switching from one motion to another can take place. Consequently, it is possible to improve the molding accuracy for press molded products and expand the productivity and adaptivity. As the motors in the servo motor sets 21a, 21b, synchronous motors using a permanent magnet, synchronous motors using a wound field, induction motors, reluctance motors, etc. can be utilized.

Additionally, instead of these AC motors, DC motors may be used. Herein, this embodiment is described on the assumption that the motors in the servo motor sets 21a, 21b are permanent magnet synchronous motors. Although FIG. 1 shows the eccentric press which is taken as an example, an alternative may be a crank press apparatus having crankshafts to move the slide up and down. Further, this embodiment may also be applied to presses by means of other mechanisms such as a link press and a knuckle press without the crank structure. In the present invention, the entire structure as described above by which the slide is moved up and down is referred to as a crank structure (claim 1). Although two connecting rods 3a, 3b are shown, the press apparatus may alternatively be provided with more than two connecting rods.

FIGS. 3A, 3B, 3C, and 3D present examples of concrete arrangements of servo motors connected in the servo motor sets. In these figures, the same reference numbers denote the same components as in FIG. 1 and FIG. 2.

For the servo motor set 21a in FIGS. 3A, 3B, and C, two servo motors are connected to a same output shaft 21ac or drive shaft 21as. A way of connecting the motors will be described later. For the servo motor set 21b, similarly, two servo motors are connected to a same output shaft 21bc or drive shaft 21bs.

FIGS. 3A and 3B present examples wherein motors are arranged on either side of the drive gears 12a, 12b. In particular, servo motors 21a1, 21a2 are connected on either side of the drive gear 12a and servo motors 21b1, 21b2 are connected on either side of the drive gear 12b. The drive shaft is short and, thereby, a well-balanced drive can be yielded. FIG. 3B presents an arrangement example wherein mechanical brake devices 31a, 32b are added to the motor arrangement as in FIG. 3A. A brake device is attached to a non-load end of one servo motor in each motor set. FIG. 3C presents an example wherein motors 21a3, 21a4 are arranged on one side of the drive gear 12a and motors 21b3, 21b are arranged on one side of the drive gear 12b and this arrangement can make the drive shafts of the motors even shorter. FIG. 3D presents an example wherein a stator part and a rotor part (surrounded by broken lines in the figure) of a plurality of motors are contained within a same frame. Motors 21a5 and 21b5 are arranged in a so-called tandem structure. As shown, each drive gear is apparently driven by a single motor. In such a structure, the motor connections are short and the space for the motors can be made even smaller.

While FIGS. 3A, 3B, 3C, and 3D present the examples wherein two motors are connected to a same drive shaft, the number of motors may be three or more, according to the power of one motor or the power required to drive the press apparatus.

In a case where additional motors are needed in consideration of the capacity required for the press apparatus, an alternative method with regard to FIG. 1 is to increase the number of drive shafts of servo motors to drive one main gear. Specifically, for example, in addition to the drive gear 12a that meshes with the main gear 11a, another drive gear may be provided and a plurality of servo motors may be placed on this shaft.

The brake devices are used to keep the slide stopped or for emergency stop of the slide. As for their arrangement, in the example of FIG. 3B, a brake device 31a is attached to a non-load end of a servo motor 21a2 and a brake device 31b is attached to a non-load end of a servo motor 21b1. The brake devices maybe arranged alternatively. For example, the brake device 31a may be attached to a non-load end of a servo motor 21a1. In consideration of the capabilities of the brakes, brake devices may be attached to all the non-load ends of servo motors 21a1, 21a2, 21b1, 21b2, respectively. Further, a special gear for brake use is disposed in conjunction with the main gears 11a and 11b and a brake device may be placed on the shaft of this gear. Alternatively, a brake device may be placed on a shaft connecting with the main gears. The presented arrangement of the brake devices can be considered to be provided in the same way with regard to FIGS. 3C and 3D. For example, in FIG. 3C, the brake devices may be disposed symmetrically with the motor arrangement with respect to each drive gear. That is, the brake devices may be attached to the drive shaft ends to which no motors are connected, as viewed from the drive gears.

Then, descriptions are provided for a way of connecting the plurality of servo motors, which is a feature of the present invention. In permanent magnetic servo motors, torque pulsations depending on rotational positions of the motors take place, such as cogging torque attributed to a magnetic circuit structure or torque pulsation due to a waveform of an armature current. Smaller toque pulsations are desirable, because the torque pulsations cause deterioration in the accuracy of positioning the slide, a decrease in responsiveness or noise during driving. In the present invention, because a plurality of motors is connected to a same shaft, the motors can be connected to cancel out the torque pulsations generated by each motor. Specifically, in a case where the motors are arranged as in FIG. 3C, when two servo motors are connected to a same output shaft 21ac, they are connected in rotational positions in which the phases of the torque pulsations generated by the two servo motors 21a3 and 21a4 will be opposite to each other. FIG. 4 presents an example wherein the rotors of two motors are connected so that their phases differ from one another in order to eliminate the torque pulsations. As shown here, the rotor 21a3r of a motor 21a3 and the rotor 21a4r of a motor 21a4 are placed on the output shaft 21ac, while their phases are adjusted so that the positions of their magnetic poles differ from one another by an electric angle of 90 degrees. The stators of the motor 21a3 and the motor 21a4 are of the same structure and placed in corresponding positions (in phase).

In an alternative manner of arranging the plurality of motors in order to reduce the torque pulsations, the rotors may be placed in phase on the output shaft 21ac, whereas the stators may be connected so that opposite phases of pulsations appear at a time. Also, both phases of the stators may be adjusted. The same manners of connection as above may also be performed for the motors 21b1 and 21b2.

Although FIG. 4 takes the motor arrangement of FIG. 3C as an example, the same manners of connection as above may also be performed for the arrangements of FIG. 3A and FIG. 3D.

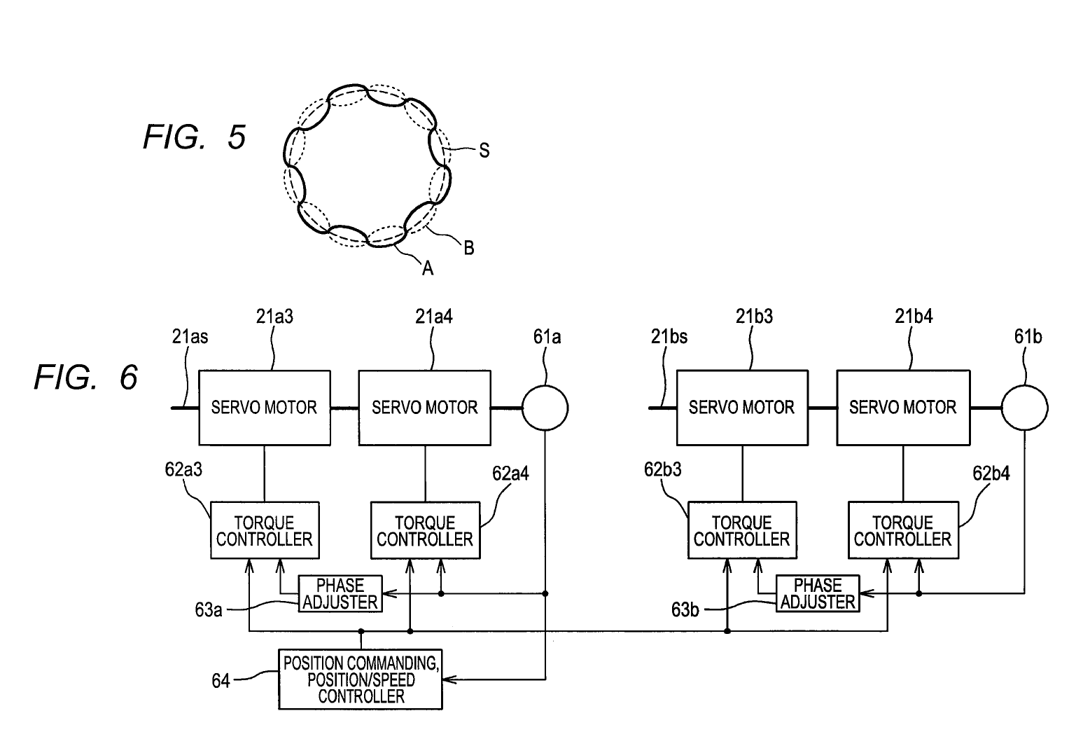

FIG. 5 presents an example wherein, when two motors are connected as described above, how the torques produced by the two motors change depending on rotational positions are represented schematically. In a circumferential direction in FIG. 5, the magnitudes of the toques are plotted. When a same current flows in the motors, this figure represents how the torques of the motors change depending on the rotational positions of the shafts of the motors. A slid line denotes the torque produced by one servo motor 21a3 and a dashed line denotes the torque produced by the other servo motor 21a4. Although FIG. 5 presents an example wherein 12 pulsations occur in one turn, the number of pulsations, in practice, may vary depending on the structures of the motors used.

The sum of the torques is output to the drive shaft 21as. Because the torque pulsations generated by each motor can be cancelled out each other, a torque output with very small torque pulsations can be achieved. A broken line S in FIG. 5 denotes such a torque output (indicating torque which can be produced by one motor corresponding to the sum of the torques produced by the two motors; that is, an average torque by dividing the sum of the torques produced by each motor by two) . As can be seen from FIG. 5, the pulsations indicated by the broken line S become very small.

When three motors are connected to a same drive shaft, they are connected so that torque pulsations, substantially, do not appear in the sum of the torques produced by the three motors. That is, when the phases of the rotors connected to the shaft are adjusted as in FIG. 4, they are connected so that the phases of the magnetic poles of the rotors will be separated from one another by an electric angle of 120 degrees. Even if four or more motors are connected, they are connected according to the same principle of connection.

In this manner of connection, a drive system with very small torque pulsations can be realized. This way of connection is suitable for arranging a plurality of motors on a same drive shaft.

FIG. 6 is a block diagram illustrating a configuration example of a control system for servo motors, when two motors are connected as in FIG. 3C and FIG. 4. In FIG. 6, an encoder 61a is connected to an end of an output shaft to which the servo motors 21a3 and 21a4 are connected and an encoder 61b is connected to an end of an output shaft to which the servo motors 21b3 and 21b4 are connected. Rotation signals from the encoder 61a are input to a position commanding/position/speed controller 64. The drive shaft 21as to which this encoder 61a is connected is regarded as a master shaft. The rotational positions and speeds of the servo motors 21a3 and 21a4, 21b3 and 21b4, in other words, the position and speed of the slide are controlled.

The position commanding/position/speed controller 64 calculates the rotational positions and speeds of the motors from a slide position command and issues the commands for the rotational positions of the motors in real time. Based on this, the controller 64 controls the rotational positions and speeds of the motors and calculates a torque command for each motor. A same torque command is issued from the position commanding/position/speed controller 64 and input to torque controllers 62a3, 62a4, 62b3, and 62b4 which drive the respective motors.

The torque controllers 62a3, 62a4, 62b3, and 62b4 have a same structure and each torque controller 62 performs control of a current that flows in each motor, according to the torque command. The torque controller 62 is comprised of a current command generator which generates a current command in accordance with the torque command, a current controller, a PWM controller, a power controller formed of power elements, a current detector which detects a current flowing in the motor, etc. Its detailed structure is well known and, hence, further discussion about it is omitted.

Signals from the encoder 61 are used as those for detecting the positions of the magnetic poles of the respective motors and input to the corresponding torque controllers 62. As illustrated in FIG. 4, two motors connected to a same drive shaft are connected with their phases adjusted to differ from one another. Thus, the magnetic poles of the motors lie in different positions with respect to a rotational position of the drive shaft. Therefore, rotation signals of one motor are phase-adjusted by a phase adjuster 63 and then input to the corresponding torque controller. If each toque controller 62 has a function of coordinating the position of a magnetic pole of the motor with a rotational position from the encoder, the phase adjuster 63 is dispensed with.

The configuration as described above enables a master-slave drive regarding the drive shaft 21as as a master shaft and the drive shaft 21bs as a slave shaft and enables well-balanced operation in which each motor outputs an even torque. Because motors connected to a same shaft as described above are connected so that their torque pulsations are reduced, a drive with little torque pulsations can be achieved.

As described herein, because two motors are connected to a same shaft, it is not required to attach an encoder to each motor and one encoder should only be attached to a same shaft. It is also possible to provide an encoder for each motor. Rather, according to the method of the present embodiment, the number of encoders is reduced and wiring for detection can be reduced; thereby, a high reliability can be achieved.

In the foregoing description, the connection of motors to a same shaft is performed such that the mechanical phases of the motors themselves are adjusted to differ from one another in order to reduce torque pulsations. Alternatively, reducing torque pulsations can also be done by means of electrical control, instead of connecting the motors to produce the phase difference effect. Specifically, torque pulsations are known by obtaining rotational positions of the motors. Current control may be performed for each of two motors to cancel out mutual pulsations of the motors. At this time, currents to cancel out the torque pulsations of the two motors are not the same; rather, it is effective to cause different currents to flow in the two motors to cancel out the pulsations each other.

If the control system is configured as in FIG. 6, in case of abnormal stop of a controller for a motor, for example, should a fault has occurred in a controller for a servo motor 21a3, only the controller for the servo motor 21a3 is stopped, while operation can easily be continued only with another normal motor. Because the drive shaft to which the stopped motor is connected is driven by the normal motor, it does not happen that the drive shaft of the stopped motor rotates idly, which would occur in a case where every motor has a drive shaft. Therefore, a drive with a high reliability can be achieved.

The press structure of the present embodiment described above, in which a plurality of motors are placed on a same drive shaft, provides for complete synchronization of the right and left crank structures with the engagement of the main gears and enables a drive with fewer gears. Thus, this press structure provides the following advantages: simple structure; small loss; downscalable; highly-responsive operation with small inertia moment is practicable; impervious to accuracy deterioration due to gear backlash; and less gear duty, as a sum of torques produced by a set of motors is only exerted on each main gear. In addition, reduced torque pulsations yield the advantages of improved accuracy in positioning the slide, high responsiveness, and low noise.

### Second Embodiment

FIG. 7 is a structural diagram of a second embodiment of the present invention. The second embodiment is characterized in that intermediate gears are added and disposed to the structure of the first embodiment.

An eccentric portion of an eccentric ring 702a engages with a hole in a large-diameter portion of a connecting rod 703a. A lower end of the connecting rod 703a is connected to a slide 701. Moreover, an eccentric portion of an eccentric ring 702b engages with a hole in a large-diameter portion of a connecting rod 703b. A lower end of the connecting rod 703b is connected to the slide 701.

Main gears 711a, 711b are connected to one ends of the eccentric rings 702a, 702b, respectively. A main gear 711a is meshed with a drive gear 712a which connects with a drive shaft of a servo motor set 721a and thus connected to the servo motor set 721a. Likewise, a main gear 711b is meshed with a drive gear 712b which connects with a drive shaft of a servo motor set 721b and thus connected to the servomotor set 721b. Further, the main gear 711a is meshed with an intermediate gear 713a and the main gear 711b is meshed with an intermediate gear 713b. The intermediate gears 713a and 713b are engaged. In this way, the main gears 711a and 711b are interlinked.

In this way, synchronization of the right and left main gears 711a and 711b is provided. In the example shown here, the main gears 711a and 711b rotate in opposite directions to each other. In the servomotor sets 721a, 721b, a plurality of motors are connected to a same shaft, as will be described later.

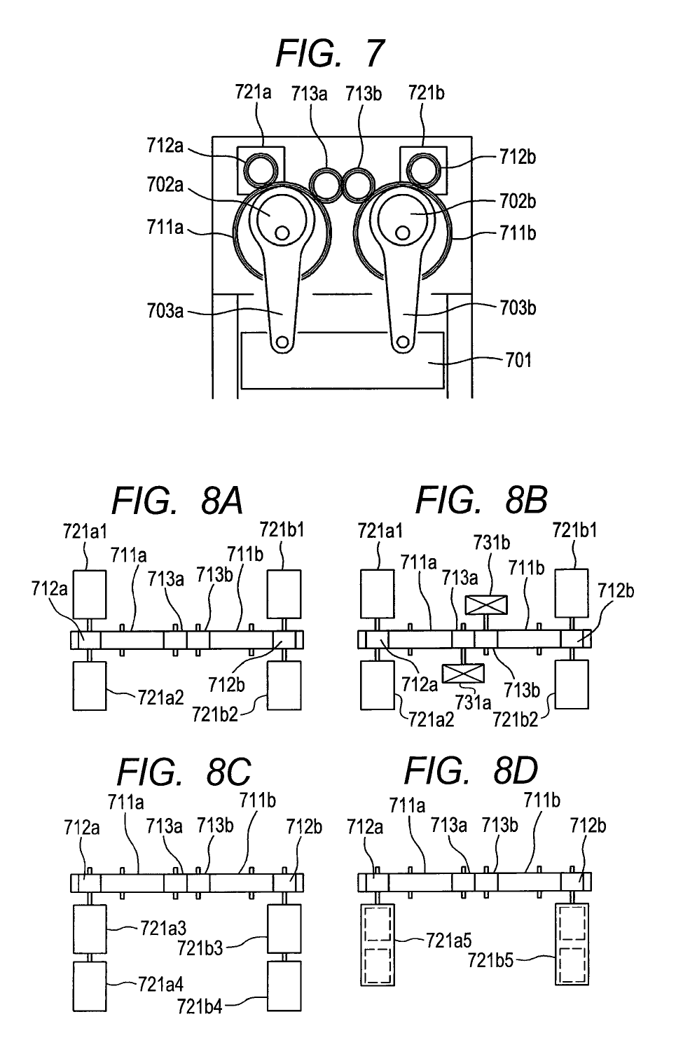

FIGS. 8A to 8D present examples of concrete arrangements of servo motors connected. In these figures, gears with the same reference numbers as in FIG. 7 represent identical ones.

For the servo motor set 721a as shown in FIGS. 8A, 8B, and 8C, two servomotors are connected to a same motor drive shaft 721as. For the servo motor set 721b, two servomotors are connected to a same motor drive shaft 721bs. FIGS. 8A and 8B present examples wherein motors are arranged on either side of the drive gears 712a, 712b. Servomotors 721a1, 721a2 are connected to the shaft on either side of the drive gear 712a, whereas servo motors 721b1, 721b2 are connected to the shaft on either side of the drive gear 712b. A well-balanced drive can be yielded.

FIG. 8B presents an example wherein mechanical brake devices 731a, 731b are added and disposed to the motor arrangement of FIG. 8A and connect to the shafts of the intermediate gears 713a and 713b. The brake devices may be arranged as illustrated with regard to the first embodiment. FIG. 8C presents an example wherein motors 721a3, 721a4 are arranged on one side of the drive gear 712a and motors 721b3, 721b4 are arranged on one side of the drive gear 712b and this arrangement can make the drive shafts of the motors even shorter. FIG. 8D presents an example wherein a stator part and a rotor part (surrounded by broken lines in the figure) of a plurality of motors are contained within a same frame. Motors 21a5 and 21b5 are arranged in a so-called tandem structure. As shown, each drive gear is apparently driven by a single motor. In such a structure, the motor connections are short and the space for the motors can be made even smaller.

In the second embodiment as well, connection of motors which are placed on a same shaft and control of the motors can be accomplished in the same way as for the first embodiment. Accordingly, a drive with reduced torque pulsations can be achieved.

### Third Embodiment

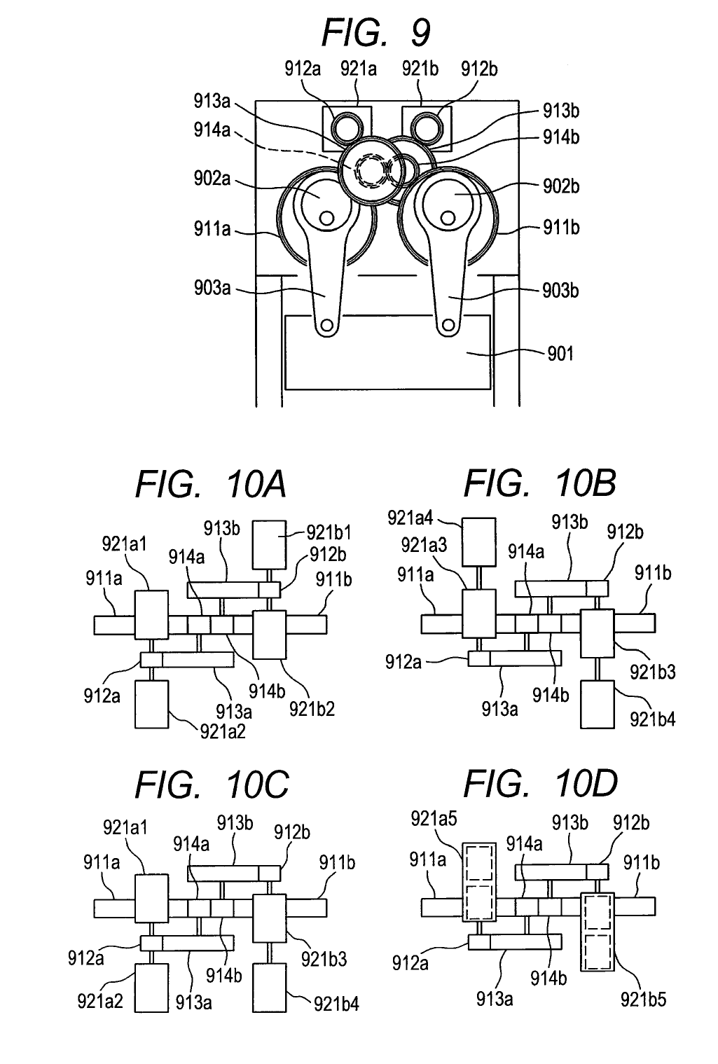

FIG. 9 is a structural diagram of a third embodiment of the present invention. The third embodiment is characterized in that a two-stage deceleration mechanism by means of intermediate gears is incorporated into the structure of the first embodiment.

An eccentric portion of an eccentric ring 902a engages with a hole in a large-diameter portion of a connecting rod 903a. A lower end of the connecting rod 903a is connected to a slide 901. Moreover, an eccentric portion of an eccentric ring 902b engages with a hole in a large-diameter portion of a connecting rod 903b. A lower end of the connecting rod 903b is connected to the slide 901. Main gears 911a, 911b are connected to one ends of the eccentric rings 902a, 902b, respectively.

A main gear 911a is meshed with a small intermediate gear 914a and a large intermediate gear 913a connected with that intermediate gear is meshed with a drive gear 912a. The drive gear 912a is interlinked with a servo motor set 921a. Likewise, a main gear 911b is meshed with a small intermediate gear 914b and a large intermediate gear 913b connected with that intermediate gear is meshed with a drive gear 912b. The drive gear 912b is interlinked with a servo motor set 921b.

Further, the small intermediate gears 914a and 914b are engaged and, via this engagement, the main gears 911a and 911b are interlinked. In this way, the right and left main gears 911a and 911b are synchronized and driven by the servo motor sets 921a and 921b. In the example shown here, the main gears 911a and 911b rotate in opposite directions to each other. In the servo motor sets 921a, 921b, a plurality of motors are connected to a same shaft, as will be described later.

In comparison with the structures of the first and second embodiments, the torques from the motor drive shafts are decelerated in two stages by the intermediate gears and then drive the main gears 911a, 911b. Therefore, the servo motor sets 921a, 921b can be run at a higher speed and smaller motors can be put into use. In addition, highly-responsive control can be implemented, because inertial moment as viewed from the motor shafts becomes smaller.

FIGS. 10A, 10B, 10C, and 10D present examples of concrete arrangements of servo motors connected. In these figures, gears with the same reference numbers as in FIG. 9 represent identical ones.

For the servo motor set 921a as shown in FIGS. 10A, 10B, and 10C, two servo motors are connected to a same motor drive shaft 921as. For the servo motor set 921b, two servo motors are connected to a same motor drive shaft 921bs. FIG. 10A presents an example wherein motors are arranged on either side of the drive gears 912a, 912b. Servo motors 921a1, 921a2 are connected to the shaft on either side of the drive gear 912a, whereas servo motors 921b1, 921b2 are connected to the shaft on either side of the drive gear 912b. A well-balanced drive can be yielded.

FIG. 10B presents an example wherein motors 921a3, 921a4 are arranged on one side of the drive gear 912a and motors 921b3, 921b4 are arranged on one side of the drive gear 912b and this arrangement can make the drive shafts of the motors even shorter. FIG. 10C presents an example wherein the motor arrangement as in FIG. 10A is adopted in a section where one drive gear is located and the motor arrangement as in FIG. 10B is adopted in a section where another drive gear is located. It is thus possible to shrink the area for arrangement of a whole set of the motors and gears. FIG. 10D presents an example in which a stator part and a rotor part (surrounded by broken lines in the figure) of a plurality of motors are contained within a same frame. Motors 921a5 and 921b5 are arranged in a so-called tandem structure. As shown, each drive gear is apparently driven by a single motor. In such a structure, the motor connections are short and the space for the motors can be made even smaller.

In the third embodiment as well, connection of motors which are placed on a same shaft and control of all motors can be accomplished in the same way as for the first embodiment. Accordingly, a drive with reduced torque pulsations can be achieved.

### Fourth Embodiment

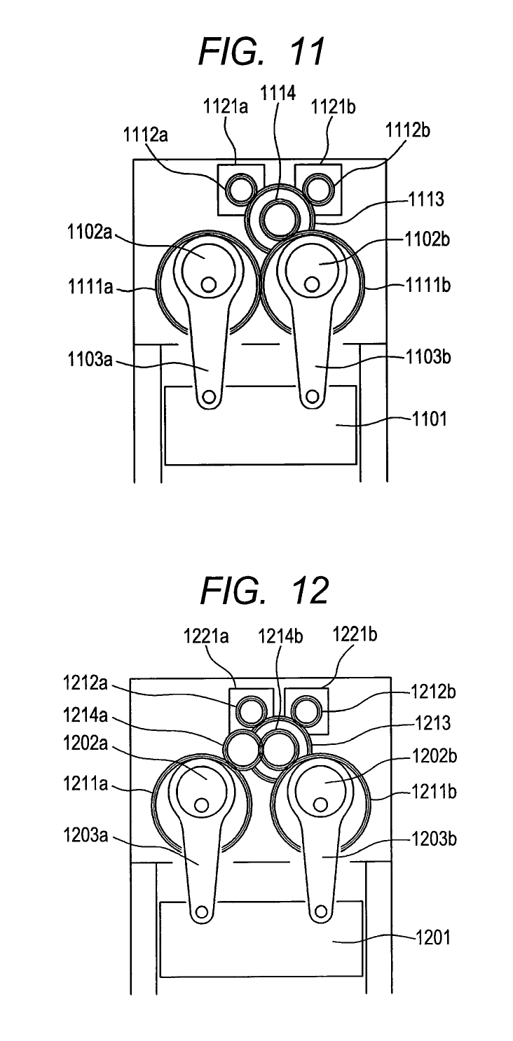

FIG. 11 is a structural diagram of a fourth embodiment of the present invention. The fourth embodiment is characterized in that the main gears are engaged in addition to the two-stage deceleration mechanism adopted as in the structure of the third embodiment.

An eccentric portion of an eccentric ring 1102a engages with a hole in a large-diameter portion of a connecting rod 1103a. A lower end of the connecting rod 1103a is connected to a slide 1101. Moreover, an eccentric portion of an eccentric ring 1102b engages with a hole in a large-diameter portion of a connecting rod 1103b. A lower end of the connecting rod 1103b is connected to the slide 1101. Main gears 1111a, 1111b are connected to one ends of the eccentric rings 1102a, 1102b, respectively.

A main gear 1111b is meshed with a small intermediate gear 1114 and a large intermediate gear 1113 connected with that intermediate gear is meshed with a drive gear 1112a and also with a drive gear 1112b. The drive gear 1112a is interlinked with a servo motor set 1121a via a drive shaft and the drive gear 1112b is interlinked with a servo motor set 1121b via a drive shaft. The main gear 1111a is engaged with the main gear 1111b.

In this way, the right and left main gears 1111a and 111b are synchronized with each other and driven by the servo motor sets 1121a and 1121b. For the servomotor sets 1121a and 1121b, a plurality of motors are connected to a same shaft, as is the case for the foregoing embodiments. Concrete arrangements of motors in the servomotor sets 1121a and 1121b can be made in the same way as presented in the foregoing examples thereof.

In comparison with the third embodiment, because of a smaller number of intermediate gears employed, the torques from the motor drive shafts are decelerated in two stages and transmitted to the main gears 11a, 112b in a simpler fashion.

In comparison with the structures of the first and second embodiments, the torques from the motor drive shafts are decelerated in two stages by the intermediate gears and then drive the main gears. Therefore, the servo motor sets can be run at a higher speed and smaller motors can be put into use. In addition, highly-responsive control can be implemented, because inertial moment as viewed from the motor shafts becomes smaller.

In the fourth embodiment as well, connection of motors which are placed on a same shaft and control of all motors can be accomplished in the same way as for the first embodiment. Accordingly, a drive with reduced torque pulsations can be achieved.

### Fifth Embodiment

FIG. 12 is a structural diagram of a fifth embodiment of the present invention. The fifth embodiment is characterized in that the two-stage deceleration mechanism is implemented using an additional intermediate gear in the structure of the third embodiment.

An eccentric portion of an eccentric ring 1202a engages with a hole in a large-diameter portion of a connecting rod 1203a. A lower end of the connecting rod 1203a is connected to a slide 1201. Moreover, an eccentric portion of an eccentric ring 1202b engages with a hole in a large-diameter portion of a connecting rod 1203b. A lower end of the connecting rod 1203b is connected to the slide 1201. Main gears 1211a, 1211b are connected to one ends of the eccentric rings 1202a, 1202b, respectively.

A main gear 1211b is meshed with a small intermediate gear 1214b and a large intermediate gear 1213 connected with that intermediate gear is meshed with a drive gear 1212a and also with a drive gear 1212b. The drive gear 1212a is interlinked with a servo motor set 1221a via a drive shaft and the drive gear 1212b is interlinked with a servo motor set 1221b via a drive shaft.

Another main gear 1211a is meshed with a small intermediate gear 1214a which is in turn meshed with the small intermediate gear 1214b. In this way, the right and left main gears 1211a and 1211b are synchronized with each other and driven by the servo motor sets 1221a and 1221b. For the servo motor sets 1221a and 1221b, a plurality of motors are connected to a same shaft, as is the case for the foregoing embodiments. Concrete arrangements of motors in the servo motor sets 1221a and 1221b can be made in the same way as presented in the foregoing examples thereof.

In comparison with the fourth embodiment, the main gears can be positioned flexibly via the intermediate gear 1214a.

In comparison with the structures of the first and second embodiments, the torques from the motor drive shafts are decelerated in two stages by the intermediate gears and then drive the main gears. Therefore, the servo motor sets can be run at a higher speed and smaller motors can be put into use. In addition, highly-responsive control can be implemented, because inertial moment as viewed from the motor shafts becomes smaller.

In the fifth embodiment as well, connection of motors which are placed on a same shaft and control of all motors can be accomplished in the same way as for the first embodiment. Accordingly, a drive with reduced torque pulsations can be achieved.

Needless to say, among the above-described embodiments, those that can be combined with one another may be implemented in combination, as appropriate.

What is claimed is:

1. A servo press apparatus driven by multiple motors, the servo press comprising:
a slide that is moved up and down by a plurality of crank structures;
a gear train that interconnects the crank structures directly or indirectly; and
a plurality of servo motor shafts connected to the gear train,
wherein a plurality of servo motors are directly placed on each of the servo motor shafts.

2. The servo press apparatus driven by multiple motors according to claim 1,
wherein the crank structures are connected to main gears and the main gears are interlinked with drive gears connected to the servo motor shafts, and
wherein the main gears are interconnected directly or via intermediate gears.

3. The servo press apparatus driven by multiple motors according to claim 1,
wherein the crank structures are connected to main gears and the main gears are interlinked via intermediate gears with drive gears connected to the servo motor shafts, and
wherein the main gears are interconnected directly or via intermediate gears.

4. The servo press apparatus driven by multiple motors according to claim 1,
wherein a plurality of servomotors are placed on a servomotor shaft such that the servo motors are arranged on either side and/or one side of a drive gear placed on the servomotor shaft connected to the gear train.

5. The servo press apparatus driven by multiple motors according to claim 1,
wherein a plurality of servo motors are placed on a servo motor shaft such that the servo motors are arranged in a tandem structure within a same frame.

6. The servo press apparatus driven by multiple motors according to claim 1,
wherein a plurality of servo motors are placed on a servo motor shaft such that the phases of the servo motors differ from one another with respect to the axis of rotation in order to cancel out mutual torque pulsations of the motors.

7. The servo press apparatus driven by multiple motors according to claim 1,
wherein an encoder is attached to each of the servomotor shafts and a plurality of servo motors placed on one of the servo motor shafts are controlled by the encoder attached to the servo motor shaft.

8. The servo press apparatus driven by multiple motors according to claim 7,
wherein one of the servo motor shafts is regarded as a master shaft and control of a plurality of servo motors is implemented.
